(19) United States
(12) Patent Application Publication
(10) Pub. No.: US 2009/0163658 A1
(43) Pub. Date: Jun. 25, 2009

(54) Process for making low color polyvinyl alcohol

(76) Inventors: Florin Barsan, Pearland, TX (US); Kien Van Phung, Pearland, TX (US); Jeffrey Hunt Thompson, Friendswood, TX (US)

Correspondence Address: FERRELLS, PLLC, P. O. BOX 312, CLIFTON, VA, 20124-1706, US

(21) Appl. No.: 12/317,114

(22) Filed: Dec. 19, 2008

Related U.S. Application Data
(60) Provisional application No. 61/008,791, filed on Dec. 21, 2007.

(51) Int. Cl. C08G 63/91

(52) U.S. Cl. 525/62

(57) ABSTRACT

A process is provided for the manufacture of polyvinyl alcohol, having an APHA color of equal to or less than about 10, by polymerizing a vinyl acetate monomer to form polyvinyl acetate and then hydrolyzing the polyvinyl acetate to form polyvinyl alcohol wherein the vinyl acetate monomer is characterized as having an inhibitor level of equal to or less than about 10 ppm, preferably less than about 5 ppm, more preferably less than about 3 ppm, even more preferably less than about 1 ppm.

### CLAIM FOR PRIORITY

This application is based upon U.S. Provisional Patent Application Ser. No. 61/008,791 (Attorney Docket No. C-7286), filed Dec. 21, 2007 of the same title, the priority of which is hereby claimed and the disclosure of which is incorporated herein by reference.

### BACKGROUND OF THE INVENTION

Vinyl acetate monomer is the primary raw material used in the manufacture of polyvinyl alcohol. Polyvinyl alcohol may be manufactured by polymerization of the vinyl acetate monomer to form polyvinyl acetate which is then partially hydrolyzed. The process of hydrolysis is based on the partial replacement of ester groups in the polyvinyl acetate with hydroxyl groups and may be completed in the presence of aqueous sodium hydroxide. Following gradual addition of a saponification agent, the polyvinyl alcohol may be precipitated, washed and dried. The degree of hydrolysis is determined by the time point at which the saponification reaction is terminated.

The vinyl acetate monomer is available in a variety of different grades which in turn may be used to manufacture multiple grades of polyvinyl alcohol. In fact, depending upon the intended application of the polyvinyl alcohol product, one grade may actually be more advantageously used than another.

A general overview of vinyl acetate products and their various uses is provided in Dow, “product safety assessment (PSA: vinyl acetate)”. The Dow safety assessment discloses that the inhibitor, hydroquinone, is added to minimize vinyl acetate polymerization under ambient conditions, allowing longer storage times. The brochure also discloses that vinyl acetate may be used as a raw material in the manufacture of polyvinyl alcohol for use in textiles, adhesives, paper sizing and fibers. Also disclosed is the use of vinyl acetate as a raw material in the manufacture of polyvinyl butyral for use as interlayers in safety glass for automotive and architectural applications.

One particular application for the polyvinyl acetate raw material is as a composite interlayer for laminated glass as generally described in U.S. Pat. No. 6,921,509 to Moran et al., the disclosure of which is incorporated by reference. In Moran composite interlayers suitable for use in laminated glass, include a layer of plasticized polyvinyl butyral, sandwiched between second and third polymeric layers. In a preferred embodiment, at least one and preferably both of the second and third layers are less than 5 mils thick and formed of polyurethane.

U.S. Pat. No. 7,452,608 to Fukatani et al., incorporated by reference, discloses a laminated glass and an intermediate film for laminated glass which is characterized as having high performance for mitigating external impact when, for instance, a head comes into collision due to the occurrence of a personal accident. The interlayer film for the laminated glass is not particularly limited but it is provided with a plasticizer in an amount of about 30 parts by weight or more, per 100 parts by weight of polyvinyl acetal resin interlayer.

Certain applications for polyvinyl alcohol, however, are particularly sensitive to the color of the polyvinyl alcohol product.

### SUMMARY OF THE INVENTION

Disclosed herein is a process for manufacturing polyvinyl alcohol having an APHA color of less than or equal to about 10 for color sensitive applications, by feeding a purified vinyl acetate composition containing ultra-low levels of inhibitor to the polyvinyl acetate polymerization reactor. The purification of the vinyl acetate was made by using two distillation columns that remove the impurities, by products, and, in particular, all or substantially all remaining inhibitor from the vinyl acetate just prior to polymerization. Specifically, the level of inhibitor is reduced to about 10 ppm or less, preferably about 5 ppm or less, even more preferably about 3 ppm or less, such as about 1 ppm or less. It is noteworthy, however, that a wide variety of methods for removing impurities and, in particular, inhibitors from a vinyl acetate stream prior to use to manufacture polyvinyl alcohol may be acceptable. Other means that may be acceptable to remove impurities and in particular inhibitors include washing the vinyl acetate with a sodium hydroxide solution or using any of a wide variety of ion exchange resins.

In the inventive process, fresh or purified vinyl acetate substantially free of impurities and inhibitors is fed directly to a suitable reactor. By using vinyl acetate substantially free of inhibitors, notable quality improvements may be achieved in the manufacture of polyvinyl alcohol grades for color sensitive applications. This process change may be particularly advantageous when employed in combination with other process controls already known for achieving color improvements in polyvinyl alcohol. It has been found that the use of vinyl acetate having a level of inhibitor of equal to or less than about 10 ppm, preferably less than about 5 ppm, more preferably less than about 3 ppm, even more preferably less than about 1 ppm, may result in a final polyvinyl alcohol product having an APHA color of about 10 or less.

It has been found that raw materials used in the manufacture of polyvinyl alcohol may be significant sources of color formation in the polyvinyl alcohol product. In particular, inhibitors and other heavy-end by-products from the vinyl acetate raw material stream may contribute to color formation in a polyvinyl alcohol product.

Polyvinyl alcohol product made according to the present invention, typically may be characterized as having an APHA color of less than or equal to about 10. Polyvinyl alcohol produced by conventional means typically may have an average APHA color of about 20 to 25. The lower the APHA color value, the more colorless the polyvinyl alcohol.

The procedure for determining the APHA color number is set forth in ASTM D1209-62T and E202-62T. This method considers the intensity of the light and measures absorption in the yellow region of the visible spectra. APHA color is calibrated against distilled water, which is assigned an APHA value of zero and differing dilutions of platinum-cobalt (Pt Co), stock solution. The Pt Co solutions are yellow as were the waste water solutions which APHA was originally designed to evaluate. With respect to polyvinyl alcohol, low color values means polymers having stable APHA colors of less than or equal to about 10. Measurement of the APHA color of the polyvinyl alcohol is conducted on a 4% solution of polyvinyl alcohol in water. Also to be considered in the measurement of APHA color, is the length of the cuvette (10, 20 or 50 mm). Other color tests are available and may be conducted based on testing of solid polyvinyl polymers instead of polyvinyl alcohol in solution, and based against a standard yellowness index.

Vinyl acetate is historically shipped in liquid form and with an inhibitor, such as hydroquinone or one or more quinine-based inhibitors. For applications requiring polyvinyl alcohol having a low color, there is a need to purify the vinyl acetate just prior to polymerization to form polyvinyl acetate to remove or minimize the presence of impurities, which may cause undesired color in the final polyvinyl alcohol product. Examples of such impurities include inhibitors, heavy ends, resins, and alcohol by products.

### DETAILED DESCRIPTION OF THE INVENTION

The quality of polyvinyl alcohol products useful for a wide variety of applications is significantly dependent on the color of the polyvinyl alcohol used to make the products. In turn, as mentioned above, the color of the polyvinyl alcohol is significantly dependent on the color of the vinyl acetate monomer that may be polymerized to make polyvinyl acetate which is then hydrolyzed to make the polyvinyl alcohol product.

In this regard, a variety of impurities have been investigated in the past to determine their effect on the color of polyvinyl alcohol products that may be used in a wide variety of applications in which low color is required.

Among the impurities typically found in vinyl acetate monomers used as raw materials in the manufacture of polyvinyl alcohol, in addition to hydroquinone are ethyl acetate, methyl acetate, acetone, acetaldehyde, crotonaldehyde, benzene and even water.

Acetone is not believed to be an impurity that may cause color or other problems in polyvinyl alcohol products.

Ethyl acetate is essentially a “pass through” in the polyvinyl alcohol process. It is essentially inert in the polymerization of the vinyl acetate monomer. Most of the ethyl acetate entering the paste stripper is sent overhead and accumulates in the recycle vinyl acetate monomer. At some point, it will move through the paste stripper and react with phosphoric acid added to the column to be converted to ethanol. This ethanol exits the base of the column and passes through the saponification step and acetic acid recovery system. In most or all conventional processes, it then reacts with the polyvinyl acetate polymer in the saponification step (as does methanol), to form ethyl acetate again. Any ethyl acetate from the saponification will pass into the acetic acid recovery system. Ethyl acetate entering the acetic acid recovery system is converted to ethanol and ultimately builds up in the methanol solvent, recycled in the process.

Methyl acetate present in the vinyl acetate monomer converted to polyvinyl alcohol, is of little or no concern because methyl acetate is a byproduct which manufacturers conventionally allow to be recycled with the recycled methanol in the manufacturing process to save energy costs.

Acetaldehyde, another so-called impurity contained in vinyl acetate monomer, is known to be a color promoting impurity in the final polyvinyl alcohol product. It is known however, that acetaldehyde can be converted to crotonaldehyde and higher aldol condensation oligomers, which are known to be good chain transfer agents, limiting molecular weight which is desirable in special grades of polyvinyl alcohol requiring lower molecular weight.

While benzene content in vinyl acetate monomers used to make polyvinyl alcohol is of concern regarding the color of the final polyvinyl product, it is generally known that higher levels of benzene in the final polyvinyl product cannot be tolerated.

As to water, it has been found that the water content in the vinyl acetate should be as close as possible to the solubility limits of vinyl acetate monomer so as not to affect the quality of the polyvinyl alcohol.

From among the above impurities, it has been found that, according to the present invention, the inhibitors are typically used to stabilize the vinyl acetate from degradation from the time it is manufactured until it is polymerized to form polyvinyl acetate. Hydroquinone is probably the dominant color causing inhibitor used to stabilize vinyl acetate, but other quinine-based materials are also used commercially, including hydroquinone monomethyl ether and benzoquinone. These inhibitors which are generally present during shipping and storage of the vinyl acetate, should be reduced to the lowest possible level, prior to polymerization of the vinyl acetate to form polyvinyl acetate to reduce the color of the final polyvinyl alcohol product to the lowest possible level.

Various methods have been disclosed for removing impurities from vinyl acetate as disclosed for instance in U.S. Pat. No. 4,487,959 to Dickerson, incorporated by reference. The impurities included acetic acid, coloration agents, water and or cations and anions. The acetic acid may be removed by azeotopic distillation.

The low color polyvinyl alcohol of the present invention may be useful for numerous applications where low color is important. For instance, polyvinyl alcohol is a main material for manufacturing polyvinyl butyral which is used as an adhesive for making laminated glass for automotive windshields, storm windows and doors, and in ballistic windows. Low color polyvinyl alcohol is also used as polarized film in liquid crystal display window applications. High color in polyvinyl alcohol such as APHA color values in excess of about 10, will affect the color of polyvinyl butyral and products made from it. High polyvinyl alcohol color values will also lead to poor aesthetic appearance and weathering resistance in polyvinyl alcohol polarized film applications.

The following examples are illustrative only and are not to be considered in any way as limiting the scope of the present invention which is set forth in the appended claims.

### Example 1

This example is provided to illustrate how vinyl acetate may be purified to remove any inhibitors. As mentioned in the above Specification, low inhibitor levels in vinyl acetate monomer are essential for reduction of high color in polyvinyl alcohol such as APHA color values. The boiling points of vinyl acetate and water are 162 degrees and 212 degrees fahrenheit respectively. In this example, an azeotrope of vinyl acetate and water are formed, having a boiling point of 151 degrees fahrenheit. The vinyl recovery column is operated in the range of 2 psig and 185 degrees fahrenheit. The vinyl acetate water azeotrope is distilled overhead, condensed, and phase separated in the accumulator. Vinyl acetate is returned to the column as reflux. The water and low boiling impurities are removed through the aqueous phase in the overhead accumulator. The high boiling impurities are removed through the column residue. The purified vinyl acetate is vapor fed to the redistillation column from the bottom of the vinyl recovery column. The redistillation column ensures that no entrained liquid containing impurities or inhibitors go into the polymerization reaction.

### Example 2

A stream of clean, clear vinyl acetate paste was prepared using purified vinyl acetate monomer, wherein the composition was more than 85% distilled, making the impurity content equal to or less than about 1 ppm. This vinyl acetate stream was used to prepare a control sample. In the study four different impurities: Acetaldehyde (“AH”), Hydroquinone (“HQ”), Hydroquinone Acetate (“HQDA”), and other acetic acid heavies such as Triacetene (herein collectively “HE-acid”), were added to the clean, clear paste, to measure color of the finished product. The Table below indicates color to be associated with higher levels of inhibitor.

TABLE

| Experiment | Acetaldehyde | HQ in | HQDA in | HE-acid in | 20 mm |
|---|---|---|---|---|---|
| No. | in ppm | ppm | ppm | ppm | APHA |
| 1 | 6 | 10 | 0 | 0 | 46.4 |
| 2 | 6 | 10 | 10 | 13 | 124.1 |
| 3 | 0 | 10 | 0 | 13 | 73.5 |
| 4 | 6 | 0 | 0 | 13 | 24.3 |
| 5 | 0 | 0 | 0 | 13 | 29.2 |
| 6 | 0 | 10 | 10 | 0 | 69.1 |
| 7 | 0 | 0 | 0 | 0 | 5.6 |

As shown in the Table above, samples of polyvinyl alcohol made according to the present invention exhibited very favorable, low color properties in comparison to the control samples.

Further experiments were conducted on vinyl acetate streams having different levels of hydroquinone. Samples of vinyl acetate having high (approximately 20 ppm), medium (approximately 10 ppm), low (trace ppm), and no levels of hydroquinone, were studied by gas chromatograph. The detection level of the gas chromatograph was about 1 ppm hydroquinone. It was concluded that hydroquinone type inhibitors in vinyl acetate streams, cause color or haze formation in the final polyvinyl alcohol product. Our conclusions with regard to the color-causing effect of hydroquinone-type inhibitors do not exclude the possibility that other types inhibitors may also cause color formation and hence effect clarity in the polyvinyl alcohol products.

These and other modifications and variations to the present invention, may be practiced by those skilled in the art, without departing from the spirit and scope of the present invention, which is more particularly set forth in the appended claims. In addition, it should be understood that aspects of the various embodiments may be interchanged in whole or in part. Furthermore, those skilled in the art will appreciate that the foregoing description is by way of example only, and is not intended to limit the invention as further described in such appended claims.

What is claimed is:

1. A process for the manufacture of polyvinyl alcohol having an APHA color of equal to or less than about 10, comprising polymerizing vinyl acetate monomer, having a level of inhibitor of about 10 ppm or less to form polyvinyl acetate and then hydrolyzing the polyvinyl acetate to form polyvinyl alcohol.

2. The process of claim 1, wherein the level of inhibitor is about 5 ppm or less.

3. The process of claim 2, wherein the level of inhibitor is about 3 ppm or less.

4. The process of claim 3 wherein the level of inhibitor is about 1 ppm or less.

5. A process for the manufacture of polyvinyl alcohol having an APHA color of equal to or less than about 10, comprising polymerizing vinyl acetate monomer, having a level of hydroquinone inhibitor of about 10 ppm or less, to form polyvinyl acetate and then hydrolyzing the polyvinyl acetate to form polyvinyl alcohol.

6. The process of claim 5 wherein the level of hydroquinone is about 5 ppm or less.

7. The process of claim 6 wherein the level of hydroquinone is about 3 ppm or less.

8. The process of claim 7 wherein the level of hydroquinone is about 1 ppm or less.

9. A process for the manufacture of laminated glass products, requiring low color, which comprises using a polyvinyl alcohol having an APHA color of less than or equal to about 10.

10. The process of claim 9 wherein the intended application for the glass product is an automotive windshield.

11. The process of claim 9 wherein the intended application for the glass product is selected from storm windows and doors.

12. The process of claim 9 wherein the intended application for the glass product is ballistic windows.
